(19) United States
(12) Patent Application Publication
(10) Pub. No.: US 2012/0120986 A1
(43) Pub. Date: May 17, 2012

(54) THERMOCOUPLE AND THERMOMETER USING THAT

(75) Inventors: Takeshi Konno, Ibaraki (JP); Mitsuru Egashira, Ibaraki (JP); Mikihiko Kobayashi, Ibaraki (JP)

(73) Assignee: NATIONAL INSTITUTE FOR MATERIALS SCIENCE, Tsukuba-shi, Ibaraki (JP)

(21) Appl. No.: 13/377,026

(22) PCT Filed: Feb. 15, 2010
(86) PCT No.: PCT/JP2010/052198

§ 371 Date: Dec. 8, 2011

(30) Foreign Application Priority Data
Jun. 17, 2009 (JP) 2009-144105

(51) Int. Cl. G01K 7/02; B23K 11/02

(52) U.S. Cl. 374/179; 219/57; 374/E07.004

(57) ABSTRACT

The invention has for its object the provision of a thermocouple having a fused portion that is kept against growing bulky in a small ball form, and a process for fabricating the same.

To accomplish that object, the inventive thermocouple has a feature that the included butt angle (a) between two thermocouple element wires (2a) and (2b) is 90° or greater. Portions of mutual contact of two thermo-couple element wires are fused and integrated into a thermo-metric contact (16) having a feature that its diameter is at most twice as large as the diameter of each element wire (2a), (2b).

### BACKGROUND OF THE INVENTION

1. Field of the Invention

The present invention relates to a thermocouple having a thermometric contact obtained by fusion and joining of two thermocouple element wires and a process for making that thermometric contact. The invention is also directed to reducing the diameter of the element wires for the purpose of detecting temperature changes in minute areas or microareas.

2. Description of the Prior Art

With advancements in MEMS and cellular phone devices, there are mounting demands toward thermal management of those devices. A feature of thermal management for such devices is that the area to be measured is minute and has low heat capacity, and temperature sensors used for thermal management for devices or the like generally include thermocouples, thermistors, and semiconductor type thermometers. A thermocouple gains a basic thermometric function by fusing and joining together two thermocouple element wires into a thermometric contact. Here, if the element wires of a thermocouple decrease in diameter to downscale the thermometric contact, that thermocouple may be applied to a temperature sensor in applications where the area to be measured is minute and has low heat capacity. That is, the finer the element wires, the more the heat resistance of the wires grow, and the smaller becomes the heat loss from what is measured. Given a minute thermometric contact, the same temperature would be reached in a small heat quantity; so the temperature of a minute area having low heat capacity could be measured.

Recent advancement in microprocessing has allowed for ready formation of flow passages, reactors or the like having diameters of the order of 1 mm or on a micrometer scale. When such a minute flow passage or reactor is downscaled to 1/100 as an example, the heat capacity goes down to 1/10⁶; so changes in input or output heat quantities bring about huge temperature changes in the reactor. For the measurement of the temperature of a fluid that flows over a minute passage, a thermocouple must be installed for a separate reason from that for an ordinary-scaled flow passage. Referring here to the ordinary-scaled flow passage, it is usual that, as depicted in FIG. 13(a), a thermocouple (17) is inserted in the vertical direction to a flow passage (15), and a thermometric contact (16) is located on the center of the passage (15). When the temperature of a fluid that flows over the passage (15) is measured, however, the large size of the thermometric contact (16) of the thermocouple (17) causes the thermocouple itself to be an obstacle to the smooth flow of the fluid. This in turn causes the boundaries between the thermometric contact (16) and the element wires (16a), (16b) to receive huge force, ending up with possible damage to the thermocouple. To avoid this, the element wires (16a), (16b) are located parallel with the flow passage (15), as depicted in FIG. 13(b), or the thermometric contact (16) is located on the inner wall of the passage, as depicted in FIG. 13(c). For the arrangements of FIGS. 13(b) and 13(c) on the idea of reducing fluid resistance as much as possible, as a matter of course, it is desirable that the increase in the size of the thermometric contact (16) of the thermocouple be avoided as much as possible.

In such situations, the thermocouple has the thermometric contact (16) obtained by fusion and joining of two thermocouple element wires. For faster response, it is considered helpful to reduce the element wire diameter and the volume of the thermometric contact; as far as the state of the art is concerned, however, the reduced wire diameter would not necessarily have correlations to performance improvements.

### LISTING OF THE PRIOR ART

### Patent Publications

Patent Publication 1: JP(A) 2009-25294

### SUMMARY OF THE INVENTION

The situations being like this, the present invention has for its object to provide a fused portion (thermometric contact) that has a higher response feature than ever before, provided that the criterion unit is an element wire diameter.

### Means for Accomplishing the Object

According to the first aspect of the invention, there is a thermocouple provided which has a thermometric contact obtained by fusion and joining of two thermocouple element wires, characterized in that an included butt angle between the two element wires with the thermometric contact as center is 90° or greater.

According to the second aspect of the invention, the thermocouple of the first aspect is further characterized in that the diameter of each or the thermocouple element wire is up to 100 μm.

According to the third aspect of the invention, the thermocouple of the first or second aspect is further characterized in that the diameter of the thermometric contact is at most twice as large as the diameter of each or the element wire.

According to the fourth aspect of the invention, there is a process for fabricating the thermocouple of any one of the first to third aspects provided, which is characterized in that the tips of two thermocouple element wires are brought butt and butt, and a butt-and-butt site is fused into a thermometric contact, wherein the butt angle is set in such a way as to amount to the included butt angle after the fusion.

According to the fifth aspect of the invention, the fabrication process of the fourth aspect is further characterized in that the butt-and-butt site of the element wires is fused by high-voltage microdischarging that is intermittently implemented.

According to the sixth aspect of the invention, there is a thermometer provided, which is adapted to measure electromotive force occurring at a thermometric contact of a thermocouple via its element wires to measure a temperature around the thermometric contact, characterized in that the thermocouple is any one of the thermocouples according to the first to third aspects of the invention.

### Advantages of the Invention

Experimentation has revealed that the inventive thermometric contact has a heat response rate higher than a one having a similar diameter but an included butt angle of less than 90°.

This has been confirmed by the examples given below, but the reason has yet to be clarified. A possible reason could be that in order to achieve such a large included butt angle, the butt angle just before fusion, too, can be correspondingly large enough to enable force for bringing both element wires butt and butt to focus on the butt contact, which in turn receives high pressure.

And as fusion starts at that pressure, it permits the mixed fusion of the components of both element wires to take place more quickly than ever before. In turn, this would result in uniform mixing of the components of both element wires at the thermometric contact.

Further, there is such a phenomenon getting more noticeable where the element wires have a diameter of up to 100 μm for measurement of microareas, making sure the structure best suited for thermocouples for microareas.

It is also possible to take hold of the influence of the diameter of the thermometric contact so that the diameter of the thermometric contact can be at most twice as large as the diameter of each element wire thereby obtaining a thermocouple having the fastest response speed or rate.

### BRIEF DESCRIPTION OF THE DRAWINGS

FIG. 1 is a front view of the apparatus according to Example 1.

FIG. 2 is an exploded perspective view of an element wire mount structure in Example 1.

FIG. 3 is a photograph indicative of the positions of a metal needle (or probe) and element wires shown in Example 2.

FIG. 4 is a photograph taken of the 1^{st} up to 23^{rd} high-voltage discharge flames shown in Example 2.

FIG. 5 is a photograph taken of the 24^{th} up to 31^{st} high-voltage discharge flames shown in Example 2.

FIG. 6 is a set of sequence photographs of the 32^{nd} high-voltage discharge shown in Example 2.

FIG. 7 is a photograph indicative of thermocouple changes before and after the discharge shown in Example 2.

FIG. 8 is an SEM photograph indicative of the outside configuration of a thermometric contact of Experiment No. 3 with an included butt angle of 52°, which was fused at a butt angle of 35°.

FIG. 9 is an SEM photograph indicative of the outside configuration of a thermometric contact of Experiment No. 1 with an included butt angle of 31°, which was fused at a butt angle of 26°.

FIG. 10 is an SEM photograph indicative of the outside configuration of a thermometric contact of Experiment No. 5 with an included butt angle of 110°, which was fused at a butt angle of 80°.

FIG. 11 is an SEM photograph indicative of the outside configuration of a thermometric contact of Experiment No. 6 with an included butt angle of 101°, which was fused at a butt angle of 101°.

FIG. 12 is an SEM photograph indicative of the outside configuration of a thermometric contact of Experiment No. 8 with an included butt angle of 133°, which was fused at a butt angle of 125°.

FIG. 13 is illustrative in schematic of how to measure a fluid flowing over a minute flow passage, using the ultrafine thermocouple shown in Example 2.

FIG. 14 is illustrative in schematic of the apparatus for making an estimation of the performance of the ultrafine thermocouple shown in Example 3.

FIG. 15 is illustrative of the results of measurement of the heat response feature of the ultrafine thermocouple shown in Example 3.

FIG. 16 is a graphical representation in which the results shown in FIG. 15 are equalized by the simple moving average method.

FIG. 17 is a graphical representation in which the ultrafine thermocouple of 50 μm in element wire diameter, shown in Example 4, is compared in terms of heat response capability with a commercially available thermocouple of 0.65 mm in element wire diameter.

FIG. 18 is a photograph indicative of a commercially available ultrafine thermocouple of 50 μm in element wire diameter.

FIG. 19 is a schematic front view of the measurement criterion for included butt angles (α).

### EMBODIMENTS FOR CARRYING OUT THE INVENTION

In the following examples, how to form the thermometric contact of a K thermocouple (with a chromel alloy +leg and an alumel alloy −leg) is primarily described; however, it is to be noted that this process may also be applied even to the formation of platinum-based thermocouples such as R thermocouples and B thermocouples and ultrahigh-temperature thermocouples such as WRe5:26 type thermocouples provided that they provide ultrafine thermocouples of a few tens of micrometers in element wire diameter. It is also to be noted that prior to the formation of the thermometric contact, two element wires were set using a device capable of independent movement of each element wire, while their tips were observed under a microscope. Patent Publication 1 or JP(A) 2009-25294 teaches that two element wires cross in contact with each other. In the invention, on the other hand, the tips of two element wires are brought butt and butt at a given angle in contact with each other without crossing.

### EXAMPLE 1

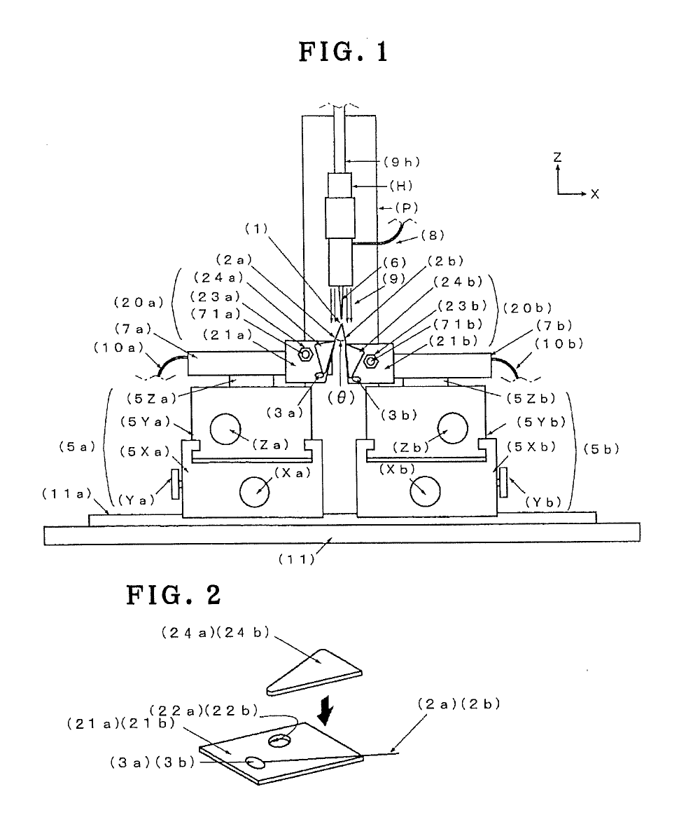

A specific example of the inventive apparatus is now explained with reference to FIGS. 1 and 2.

A base (11) and a column (P) extending upright from it were assembled in the form of a structure framework.

In the following, the X- and Z-directions are determined as shown in the right upper portion of FIG. 1, and the direction orthogonal to both directions is defined as the Y-direction.

Long rails (11a) extending in the X-direction are located on the base (11), and left and right stage assemblies (5a) and (5b) are mounted on the rails.

Each or the stage assembly (5a), (5b) is built up of an X-stage (5Xa), (5Xb) movable on the rails (11a) in the X-direction, a Y-stage (5Ya), (5Yb) movable on the X-stage in the Y-direction, and a Z-stage (5Za), (5Zb) movable on the Y-stage in the Z-direction.

Each or the stage is provided with knobs (Xa) and (Xb), (Ya) and (Yb), and (Za) and (Zb) for making its amount of movement adjustable.

Any detailed explanation of the position adjustment mechanism by these knobs is omitted because the slide mechanism well known in the art is used.

Working tables (7a) and (7b) are provided at the upper ends of the Z-stages (5Za) and (5Zb), and connected with earth or ground cables (10a) and (10b).

From the front surfaces of the working tables, there are mount shafts (71a) and (71b) extending with their axial centers directing in the Y-direction.

Thus, the positions of the mount shafts (71a) and (71b) are adjustable three-dimensionally and relatively.

Further, there are element wire-fixing structures provided which are each made up of an element wire-fixing plate (21a), (21b) having a through-hole (22a), (22b) for receiving the mount shaft (71a), (71b), a nut (23a), (23b) that is threadedly engaged with the mount shaft (71a), (71b) to fix the element wire-fixing plate (21a), (21b) at any desired angle (around the Y-axis) to the working table (7a), (7b), and a magnet keep plate (24a), (24b) for urging an element wire against the fixing plate.

The column (P) is fixedly provided with a holder (H) at a vertically given position, and a lower end of that holder is provided with a discharging metal needle (6) formed of tungsten, around which there is a gas jet pore (not shown) provided. A gas coming out of a gas hose (9h) is jetted in such a way as to wrap up the metal needle (6) around it.

Note here that reference numeral (8) stands for a cable for supplying electric power to the metal needle (6).

How to create a thermocouple using the thus assembled apparatus is now explained.

The left and right element wire-fixing structures are removed out of the working tables (7a) and (7b), and one ends of the element wires (2a) and (2b) are soldered at (3a) and (3b) to the respective element wire-fixing plates (21a) and (21b).

Then, the opposite ends of the element wires (2a) and (2b) are pulled out straightforward in the given direction shown in FIG. 2, and pressed down with the keep plates (24a) and (24b) so that they are mounted on the element wire-fixing structures (20a) and (20b).

Then, using the nuts (23a) and (23b), the element wire-fixing structures (20a) and (20b) are fixed to the mount shafts (71a) and (71b) while the leading tips of the element wires (2a) and (2b) are opposite to each other.

Then, the stages (5a) and (5b) are adjusted such that just below the metal needle (6), the leading tips of the element wires (2a) and (2b) are in opposition to and in contact at (1) with each other.

Then, a predetermined power input is supplied and an inert gas flow (9) is created to generate an inert gas atmosphere in which there is a discharge generated between the metal needle (6) and the site of opposite contact (1) thereby fusing and integrating both element wires at the site of contact.

An example of creation of a thermocouple using that apparatus is now explained.

In the instant example, an alumel alloy wire of 50 μm in diameter was used as the element wire (2a) and a chromel alloy wire of 50 μm in diameter was used as the element wire (2b).

Both element wires have a large melting point difference and are susceptible of oxidization at high temperatures; so they are less susceptible of being joined together.

The element wires were attached to the element wire-fixing structures (20a) and (20b) such that their tips projected out about 5 mm.

Then, the stages (5a) and 5(b) were operated whereby the element wires (2a) and (2b) were in opposition to and in contact with each other as shown in FIG. 1.

Here the element wires were pressed enough to move the chromel alloy wire 20 μm toward the alumel alloy wire thereby brining their tips in contact with each other. Suppose here that the alumel alloy had a Young modulus of 70 GPa. By calculation, a load on the tips of the element wires was found to be 1 mg. The metal needle (6) as an application electrode of 0.125 mm in diameter was vertically located such that its tip was positioned less than about 50 μm just above the site of opposite contact (1). The metal needle (6) was set on the voltage-application side of a pulsated high-voltage supply source, and the ground potential was the same as that of the element wire-fixing plates (21a) and (21b). With an inert gas (9) flowing from above the metal needle, high voltage was repeatedly applied to the metal needle for not longer than 0.5 second for discharge between the metal needle and the site of contact so that the site of contact is fused and joined together.

It is here to be noted that during discharge, currents actually flow at a pulse of about 10 kHz, because a Cockcroft Walton circuit, wherein once discharge occurs, voltage returns back at high speed, is used as the supply source.

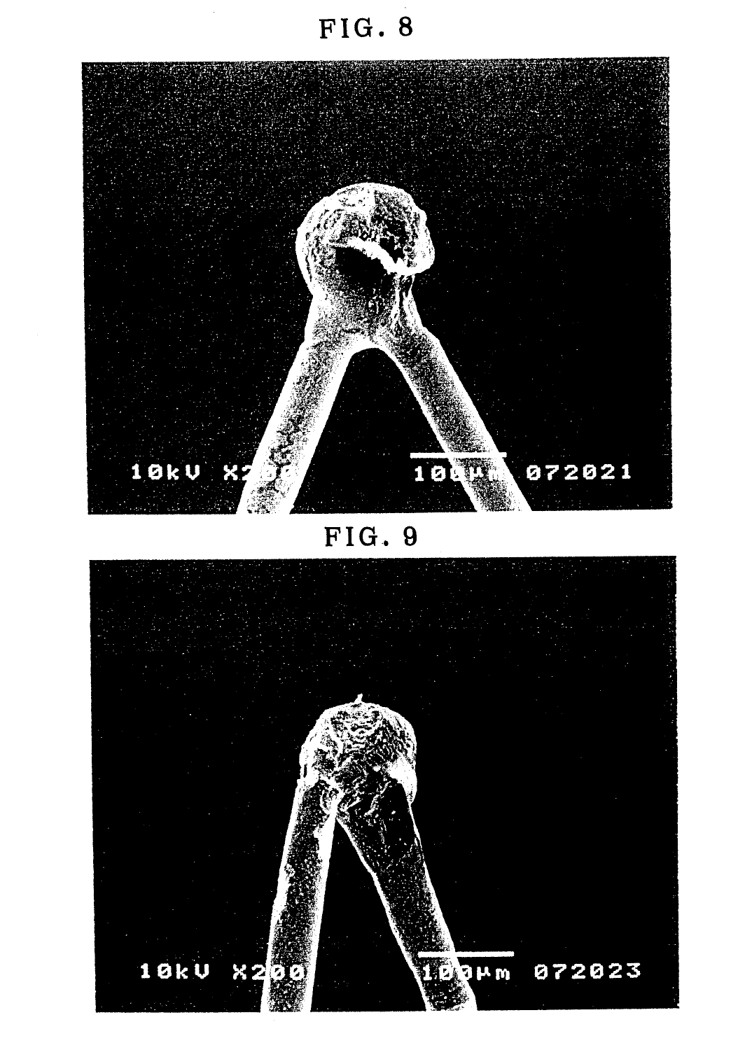

The thermometric contacts that were thus fabricated by discharge joining of the thermocouple element wires are shown in FIGS. 8 to 12.

The thermocouples are now considered in the following Example 2.

### EXAMPLE 2

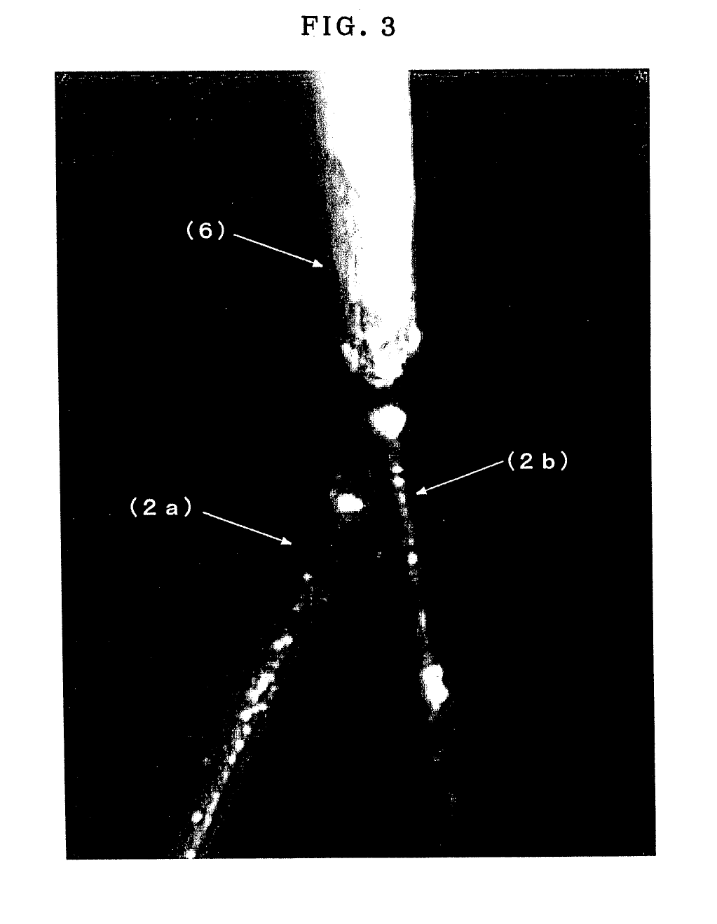

FIG. 3 is illustrative of where the metal needle is positioned just above the thermocouple element wires. The tip of the metal needle is positioned about 50 μm just above the tips of the element wires. In this state, discharge was repeatedly implemented in a rated current of 8 mA for a discharge time of 0.5 second or less per discharge with the application of 5 kV. Consequently, two element wires were fused and joined together at the 32^{nd} discharge. Note here that inert carbon dioxide gas flowed at a rate of 1 liter per minute from before the start of discharge until the end of discharge.

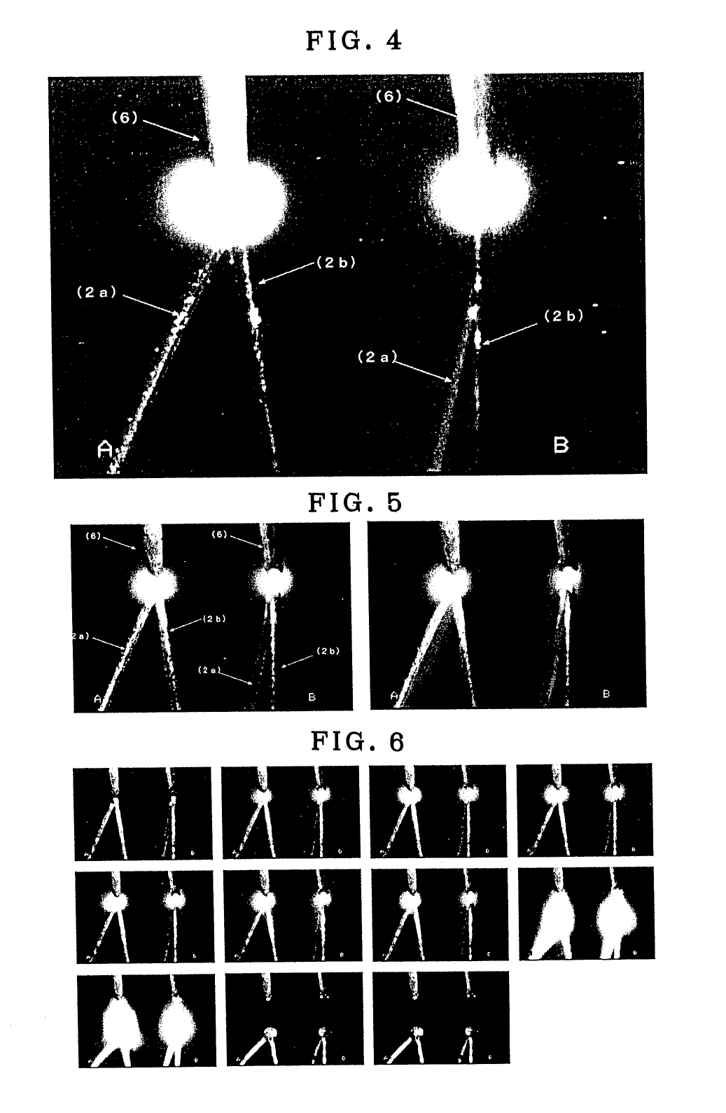

From video observation of how the repeated discharge took place, it was found that all the way from the beginning up to the 23^{rd} discharge, only such discharge flames as shown in FIG. 4 appeared between the metal needle and the forefront tips of the thermocouple element wires. There are two images appearing on one single photograph for the reason that the same sample was imaged from separate directions. The same will apply to the following FIGS. 5 and 6.

In the discharge cycles from the 24^{th} to the 31^{st} discharge, two discharge flames shown in FIG. 5 take turns appearing. At the 24^{th} discharge, there is the same discharge flame as that at up to 23^{rd} discharge appearing: the same discharge flame occurring between the metal needle and the forefront tips of the thermocouple element wires (see the photograph at the left end of FIG. 5), but this flame turns into such a discharge flame as wrapping up the element wires on the way. That is, there are discharge flames appearing around the element wires too (see the photograph at the right end of FIG. 5).

For the 32^{nd} discharge, there are video images from the beginning to the end given in FIG. 6, wherein the sequence photographs were taken at an interval of 1/30 second.

In just about 0.2 second after the start of discharge, discharge flame occurring between the metal needle and the forefront tips of the thermocouple element wires turns into such a flame as wrapping up the element wires, whereupon the whole of the element wires grew incandescent, ending up with the fusion and joining of the element wires. About 0.3 second is taken for the 32^{nd} discharge. In other joining examples, too, there is a process taking place, in which a discharge flame concentrates on the tips of the element wires at the start of discharge, and after the elapse of some time, it turns into such a discharge flame as wrapping up the element wires, and eventually the element wires grow incandescent for fusion and joining.

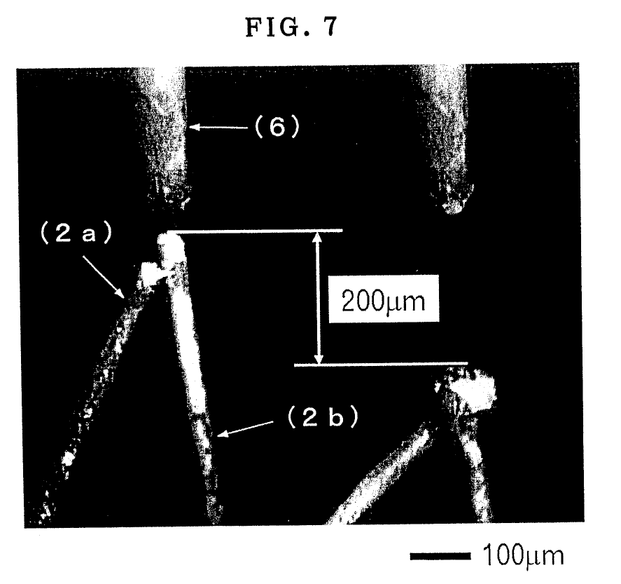

FIG. 7 is one frame of the video image illustrative of what states the element wires are in before and after discharge. Before discharge joining the butt angle (θ) of the element wires is 35°, and the included butt angle (α) after the end of discharge is 52°. Further, with the element wires fused and joined together, the distance between the probe's tip and the thermometric contact (the site of contact of the element wires) became as long as about 200 μm.

It is here to be noted that the included butt angle (α) is defined by an included angle (α) subtended between the axial centers of the both element wires extending from the middle (C) of the thermometric contact, as depicted in FIG. 19.

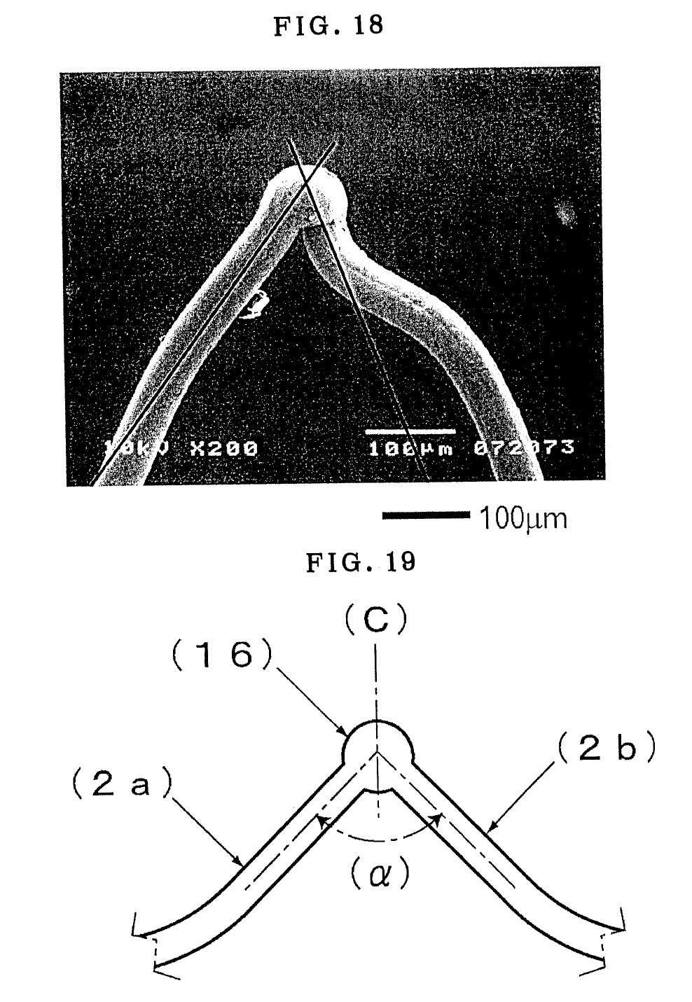

Set out in Table 1 are exemplary joining examples in which all the element wires had a diameter of 50 μm, with the included butt angle between the element wires tending to grow large after discharge. A possible reason for the distance becoming long could be that the element wires grow incandescent and soften, and the site of fusion goes down due to the discharge pressure, although any reason has yet to be clarified. A photograph taken of a commercial available thermocouple having a wire diameter of 50 μm is attached hereto as FIG. 18. The reference line shown in FIG. 19 is drawn on that photograph to figure out the included butt angle (a) of the commercial product, which is mentioned at the last row of Table 1.

FIGS. 8 to 12 are SEM photographs of the outside configurations of the formed ultrafine thermocouples. As the tips of the element wires are fused by discharge joining, it permits some to be sputtered off, and some to be fused into a round shape; so the element wires become short as a whole. When a certain contact force remains acting on the element wires, they become short, yet the whole of the element wires works as a spring to engage their tips with each other, resulting in no possibility of disengagement. The metal fused at the tips of the element wires is rounded enough to cover up the site of contact at the tips under interfacial force, and from the time of the end of discharge, the metal is rapidly cooled and solidified, forming the thermometric contact.

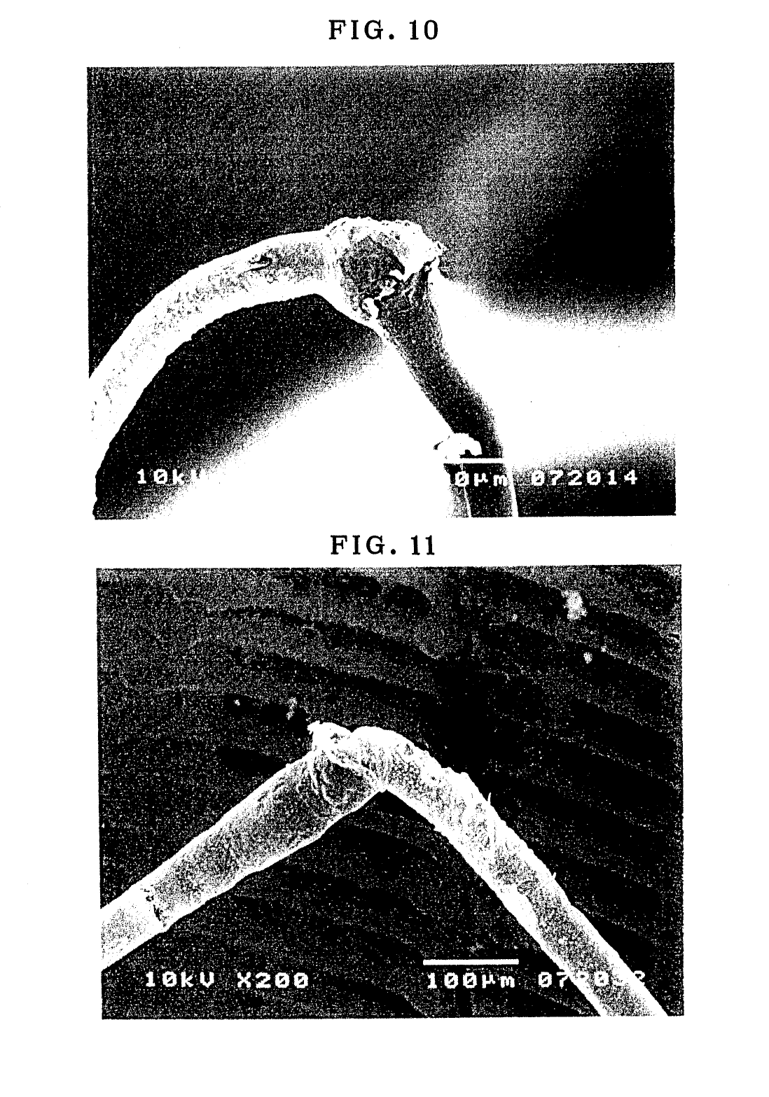

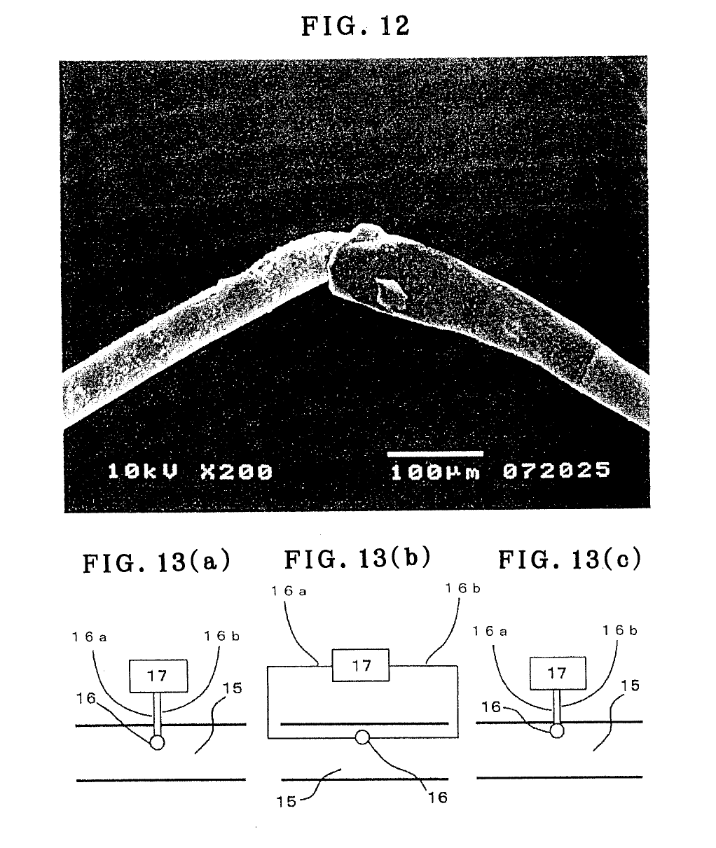

TABLE 1

| | Butt | | Diameter | Heat | |
|---|---|---|---|---|---|
| | Angle | | of Fused | Response | |
| | (deg) | | Contact | Speed | Photograph |
| Experiment No. | θ | α | μm | deg/s | No. |
| 1 | 26 | 31 | 121 | 904 | FIG. 9 |
| 2 | 30 | 34 | 114 | 904 | |
| 3 | 35 | 52 | 126 | 870 | FIG. 8 |
| 4 | 70 | 85 | 121 | 870 | |
| 5 | 80 | 110 | 114 | 995 | FIG. 10 |
| 6 | 101 | 101 | 70 | 1,010 | FIG. 11 |
| 7 | 110 | 95 | 68 | 1,152 | |
| 8 | 125 | 133 | 75 | 1,165 | FIG. 12 |
| Commercial | — | 58 | 91 | 916 | FIG. 18 |
| Product | | | | | |

θ: Butt angle before discharge
α: Butt angle for discharge

### EXAMPLE 3

The performance of the above-mentioned thermocouples was estimated.

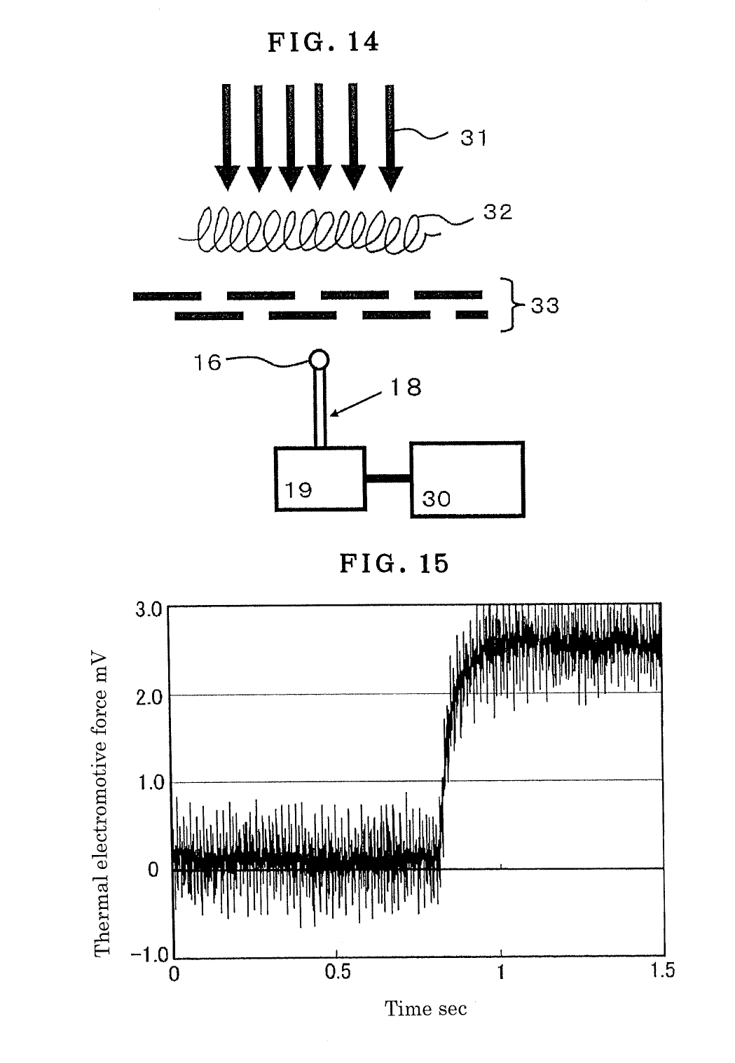

FIG. 14 is illustrative in schematic of the apparatus for making an estimation of the performance of the inventive ultrafine thermocouples. The thermometric contact (16) of each or the ultrafine thermocouple is fixed at an aerial point a constant distance away from a shutter (33) without being in touch with surrounding substances, and warmed air is blown to it from above to measure the thermal electromotive force through an amplifier (19) using a fast digital oscilloscope (30).

In this case, with the shutter (33) remaining shut down, currents are passed through a heater (32) and wind (31) is supplied at a constant speed. After the elapse of a sufficient time during which the temperature of warmed air reaches a steady state, the shutter (33) is opened to feed warmed air to an ultrafine thermocouple (18) until the thermal electromotive force is kept constant. This operation was implemented for all the thermocouples set out in Table 1. In other words, all the thermocouples set out in Table 1 were rapidly heated under the same conditions to examine the rising speeds (heat response speeds) of thermal electromotive force.

Raw data (Experiment No. 5 in Table 1) captured in the digital oscilloscope are graphed in FIG. 15 as an example. Thermal electromotive force is so very small that it is amplified 100 times as high, leading unavoidably to increased noises.

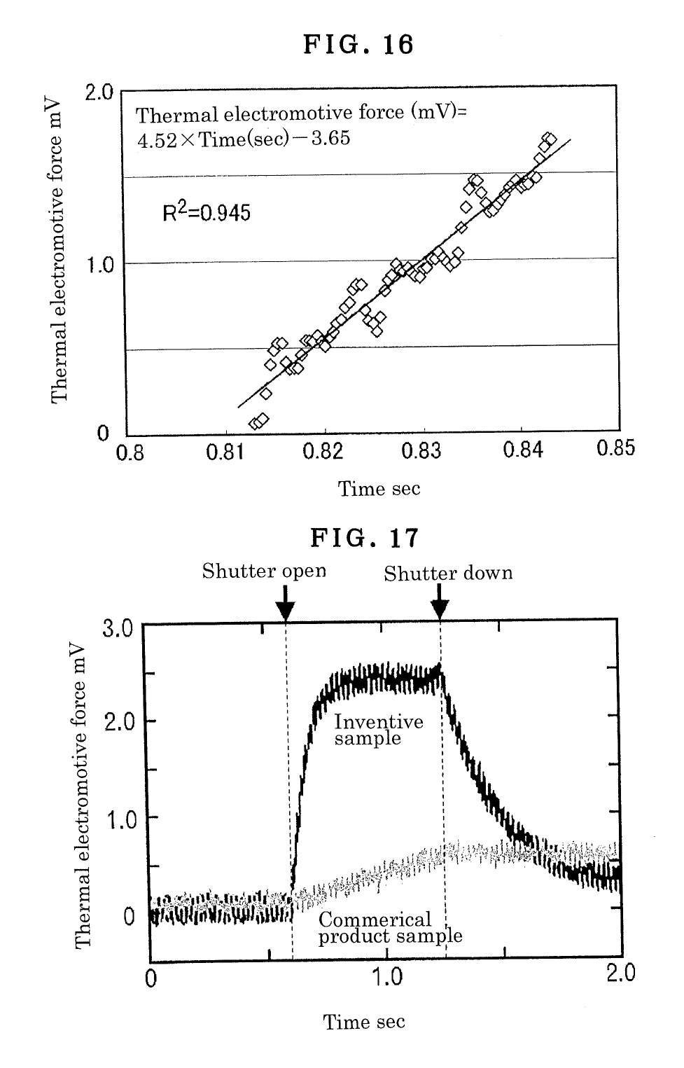

To remove the noises from those data to find out the heat response speed, therefore, the simple moving average method was relied upon. That is, the first five points out of time-series data (thermal electromotive force) are averaged. Then, the next time-series data are added and the oldest data are deleted to figure out the average of fresh five-point data. This sequence is repeatedly implemented for data from the point at which the thermal electromotive force starts rising until the thermal electromotive force reaches a half of the maximum value. It is FIG. 16 that the obtained averages are graphed in. This graph has still the influence of noises; so the gradient of this graph is found by the least square method to determine the heat response speed.

The results are set out in Table 1, from which it has been found that at an included butt angle (α) of greater than 90°, there is performance obtained that surpasses that of the commercial product: the thermometric contact having a diameter at most twice as large as the element wire diameter has a heat response speed of 1,000 deg/second or greater.

Note here that Experiment Nos. 1, 2, 3 and 4 in Table 1 are comparative examples for the first aspect of the invention, and Experiment No. 5 is a comparative example for the third aspect of the invention.

### EXAMPLE 4

Then, a commercial product having an element wire diameter of 0.65 mm and the inventive thermocouple were compared on the same apparatus.

This time the above-mentioned two thermocouple thermometric contacts were fixed as close to each other as possible so that both were simultaneously heated under the same conditions. In 0.7 second after the shutter opened, it shut down.

FIG. 17 is indicative of a change-with-time of the thermal electromotive force before and after the blowing of warmed air. By the time the warmed air was blown, both the commercial and the inventive sample were zero in terms of thermal electromotive force. The moment the warmed air was blown upon the opening of the shutter, however, the electromotive force of the inventive sample went up rapidly and reached a constant value after about 0.2 second: the inventive sample had a thermal electromotive force matching the temperature of the warmed air. In addition, just after the shutdown of the shutter, the thermal electromotive force goes down rapidly, if not so quick as it rises up.

On the other hand, the thermal electromotive force of the commercial sample, too, starts to go up from just after the blowing, but the speed is much lower than that of the inventive sample, and upon the shutdown of the shutter, the electromotive force does not reach even a half of that of the inventive sample. Even after the shutdown of the shutter, there is no drop of electromotive force.

Hence, the inventive ultrafine thermocouple is much superior in terms of the response speed to the commercial thermocouple having an element wire diameter of 0.65 mm, and provides an effective response to a drop of external temperature as well.

### Possible Applications to the Industry

The thermocouple of the invention enables measurement having a high response feature that has been considered impossible thus far in the art, and the thermocouples having such a feature would be considered useful in the following fields. Electronic parts or devices: with advancements in the high degree of integration of CPUs, other integrated circuit devices or the like, surface temperature measurements of microprocessors and other integrated circuit device parts are implemented for the purpose of devices' stable operation; and micro-TAS fields: microprocessing techniques are actively used to fabricate pumps, valves, flow passages or the like on chips for the purpose of fast analysis of biological molecules, diagnosis due to trace bloods, determination of efficacy of medicals, synthesis and analysis of chemical substances, and microchemistry techniques for implementing environmental monitoring on chips. In these fields, the inventive thermocouples may have applications to on-chip temperature measurement and control because what is measured is minute and has limited heat capacity. The inventive thermocouples may have domestic applications as electronic thermometers and cooking thermometers, and may be built in cooking equipment. Further, the inventive thermocouples may be used for temperature measurements in plants and general studies about heat as well as direct temperature measurement and identification of temperature simulations. In various thermal analyses such as differential heat analyses and thermogravity, too, the inventive thermocouples may be expected to help improve measurement accuracy, curtail measurement times and reduce the amount of samples used, etc.

### EXPLANATION OF REFERENCE NUMERALS

(1) Site of opposite contact
(10a), (10b) Earth cable
(11) Base
(11a) Rails
(15) Flow passage
(16) Thermometric contact
(17), (18) Thermocouple
(19) Amplifier
(20a), (20b) Element wire-fixing structure
(21a), (21b) Element wire-fixing plate
(22a), (22b) Through-hole
(23a), (23b) Nut
(24a), (24b) Keep plate
(2a), (2b), (16a), (16b) Element wire
(30) Digital oscilloscope
(31) Wind
(32) Heater
(33) Shutter
(3a), (3b) Soldering
(5Xa), (5Xb) X-stage
(5Ya), (5Yb) Y-stage
(5Za), (5Zb) Z-stage
(5a), (5b) Left and right stages
(6) Metal needle
(71a), (71b) Mount shaft
(7a), (7b) Working table
(8) Power supply cable
(9) Gas flow
(9h) Gas hose
(H) Holder
(P) Column
(Xa), (Xb) X-adjustment knob
(Ya), (Yb) Y-adjustment knob
(Za), (Zb) Z-adjustment knob
(θ) Butt angle
(α) Included butt angle

1. A thermocouple having a thermometric contact obtained by fusion and joining of two thermocouple element wires, characterized in that an included butt angle between the two element wires with the thermometric contact as center is 90° or greater.

2. A thermocouple as recited in claim 1, characterized in that each or the thermocouple element wire has a diameter of up to 100 □m.

3. A thermocouple as recited in claim 1, characterized in that the thermometric contact has a diameter at most twice as large as a diameter of each element wire.

4. A process for fabricating a thermocouple as recited in claim 1, in which tips of two element wires are brought butt and butt and a butt-and-butt site is fused into a thermometric contact, characterized in that a butt angle is set in such a way as to become the included butt angle after fusion.

5. A process for fabricating a thermocouple as recited in claim 4, characterized in that a butt-and-butt site of the element wires is fused by high-voltage micro-discharge that is intermittently implemented.

6. A thermometer adapted to measure electromotive force occurring at a thermometric contact of a thermo-couple by way of element wires thereof thereby measuring a temperature around the thermometric contact, characterized in that the thermocouple is any one of the thermocouples as recited in claim 1.
